(19) United States
(12) Patent Application Publication
(10) Pub. No.: US 2007/0108909 A1
(43) Pub. Date: May 17, 2007

(54) Plasma display module

(76) Inventor: Kwang-Jin Jeong, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/594,754

(22) Filed: Nov. 9, 2006

(30) Foreign Application Priority Data
Nov. 12, 2005 (KR) 10-2005-0108298

(51) Int. Cl. H01J 17/02; H01J 61/02

(52) U.S. Cl. 313/613

(57) ABSTRACT

A plasma display module including a chassis base having a grounding area, a plasma display panel attached to the chassis base, a circuit board configured to supply driving signals to the plasma display panel, a first driving cable connecting the circuit board to the plasma display panel, and a second driving cable having a first end connected to the plasma display panel and a second end connected to a rear surface of the plasma display panel, the second driving cable forms a substantially round curve between the first end and the second end, and the substantially round curve contacts and is grounded to the grounding area of the chassis base.

### BACKGROUND OF THE INVENTION

1. Field of the Invention

The present invention relates to a plasma display module. More particularly, the present invention relates to a plasma display module having a grounding structure for electrodes.

2. Description of the Related Art

Plasma display modules, which may be flat display modules for displaying images using a gas discharge phenomenon, may provide various advantages, such as high display capacity, high luminance, high contrast, low generation of afterimages, and a wide-range viewing angle. Plasma display modules have attracted considerable attention as next-generation flat display modules because they may be thin and large in size as compared to other flat display panels.

FIG. 1 illustrates a diagram of a plan view of a conventional plasma display module. The plasma display module may include a plasma display panel 30 having a first panel 10 and a second panel 20. The plasma display module may include an X driver, a Y driver, and an address driver that apply driving signals to the plasma display panel 30. A plurality of electrodes X, Y, and A that contribute to display discharge may be arranged on the plasma display panel 30. For example, a plurality of sustain electrodes X and a plurality of scan electrodes Y may extend parallel to each other and may be arranged on the first panel 10. A plurality of address electrodes A that perpendicularly cross the sustain electrodes X and the scan electrodes Y may be arranged on the second panel 20. The sustain electrodes X and the scan electrodes Y may be electrically coupled to the X driver and the Y driver to receive driving signals from the X driver and the Y driver, respectively. The address electrodes A may be electrically coupled to the address driver to receive an address signal from the address driver.

The sustain electrodes X and the scan electrodes Y may form a plurality of sustain electrode X and scan electrode Y pairs. A display discharge may occur between a sustain electrode X and a scan electrode Y pair. An area portion where the sustain electrode X and the scan electrode Y pair perpendicularly cross an address electrode A may be defined as a sub-pixel 31. A plurality of sub-pixels 31 may be arranged horizontally and vertically in a space 35. The space 35 may be an area where the first panel 10 and the second panel 20 overlap with each other.

A pixel may include a plurality of sub-pixels 31. For example, three sub-pixels emitting, for example, different colors, such as red (R), green (G), and blue (B) sub-pixels 31 may constitute a pixel.

The plasma display panel 30 may be driven during a repetition of a driving period. In an exemplary operation, the driving period may include a reset period, an address period, and a sustain period. During the reset period, the charge states of all of the sub-pixels 31 may become uniform. During the address period, address discharge may occur in selected sub-pixels 31 by applying sequentially-controlled address signals to the address electrodes A. Wall charges may be accumulated in the sub-pixels 31 that have undergone address discharge. As a result, a predetermined wall voltage may be formed in the selected sub-pixels 31. During the sustain period, predetermined voltage pulses may be applied to all of the sustain electrodes X and the scan electrodes Y. The voltage pulses may include, for example, a sustain discharge voltage that alternates with a ground voltage. Accordingly, a voltage equal to or higher than a discharge start voltage may be formed in the sub-pixels 31. That is, the predetermined wall voltage and the sustain discharge voltage may form a discharge start voltage so that display discharge may be generated.

As described above, in a conventional plasma display module, voltage pulses may be applied to the sustain electrodes X and the scan electrodes Y. That is, both the X driver and the Y driver may apply driving signals to the sustain electrodes X and the scan electrodes Y, respectively. Each of the X driver, Y driver, and the address driver may be a high-priced circuit board. The high-priced circuit board may include a plurality of mounted circuits. Thus, manufacturing costs for plasma display modules have been increasing.

Additionally, the circuit board of each driver may generate significant heat according to its operation. If this high heat is not rapidly removed, it may accumulate and degrade the circuits on the circuit board and hinder the operation of the plasma display module. Hence, a special heat conduction structure may be required to prevent heat from accumulating in a narrow enclosure where a plurality of circuit boards may be integrated. Further, a circuit board that generates a periodical electrical signal may produce noise and/or vibrations. The noise and/or vibrations may propagate, and the quality of displaying images by the plasma display module may be degraded. Thus, a plasma display module having a plurality of circuit boards may require a special vibration damping structure for reducing noise and/or vibrations.

### SUMMARY OF THE INVENTION

The present invention is therefore directed to a plasma display module that substantially overcomes one or more of the problems due to the limitations and disadvantages of the related art.

It is therefore a feature of an exemplary embodiment of the present invention to provide a plasma display module having a grounding structure for electrodes.

It is therefore another feature of an exemplary embodiment of the present invention to provide a plasma display module with a heat conduction sheet and a conductive chassis base that may be employed as a low cost means for conducting heat and/or damping vibrations.

At least one of the above and other features and advantages of the present invention may be realized by providing a plasma display module that may include a chassis base having a grounding area, a plasma display panel attached to the chassis base, a circuit board configured to supply driving signals to the plasma display panel, a first driving cable connecting the circuit board to the plasma display panel, and a second driving cable having a first end connected to the plasma display panel and a second end connected to a rear surface of the plasma display panel, wherein the second driving cable forms a substantially round curve between the first end and the second end, and the substantially round curve may contact and may be grounded to the grounding area of the chassis base.

The second driving cable may include a conductive pattern layer having a first surface and a second surface, and a cover film that may cover the first surface and a portion of the second surface of the conductive pattern layer, the second surface of the conductive pattern layer may not be covered at the substantially round curve so as to electrically contact the grounding area of the chassis base.

The plasma display panel may include an arrangement of electrodes and the first end of the second driving cable may connect to an electrode.

The plasma display panel may include a front panel and a rear panel, and the first end of the second driving cable may be connected to the electrode at a rear surface of the front panel. The first end of the second driving cable may be connected to the electrode by an anisotropic conductive adhesive.

The arrangement of electrodes may include a scan electrode and a sustain electrode, the first end of the second driving cable may connect to the sustain electrode and the first driving cable may connect to the scan electrode.

The plasma display module may be driven by a repetition of a driving period, and the grounding area of the chassis base may provide a ground voltage to the sustain electrode during the driving period.

The adhesive tape may be positioned along a perimeter portion of the rear surface of the rear panel.

The second end of the driving cable may be attached to a rear surface of the rear panel by a dual adhesive tape. The dual adhesive tape may be positioned along a perimeter portion of the rear surface of the rear panel. The dual adhesive tape may attach the plasma display panel to the chassis base.

The grounding area of the chassis base may be a front surface of the chassis base.

At least one of the above and other features and advantages of the present invention may be realized by providing a plasma display module that may include a chassis base having a grounding area, a plasma display panel attached to the chassis base, a circuit board configured to supply driving signals to the plasma display panel, a first driving cable connecting the circuit board to the plasma display panel, and a second driving cable having a first end and a second end connected to the plasma display panel, where a segment of the second driving cable between the first end and the second end may contact and may be grounded to the grounding area of the chassis base.

The plasma display panel may include a front panel and a rear panel, and the segment of the second driving cable may wrap from a rear side of the front panel to a rear side of the rear panel.

The second driving cable may include a conductive layer and cover films covering both sides of the conductive layer, and the segment may have a portion of the cover film removed so that electrical contact is made between the segment and the grounding area of the chassis base.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a diagram of a plan view of a conventional plasma display module;

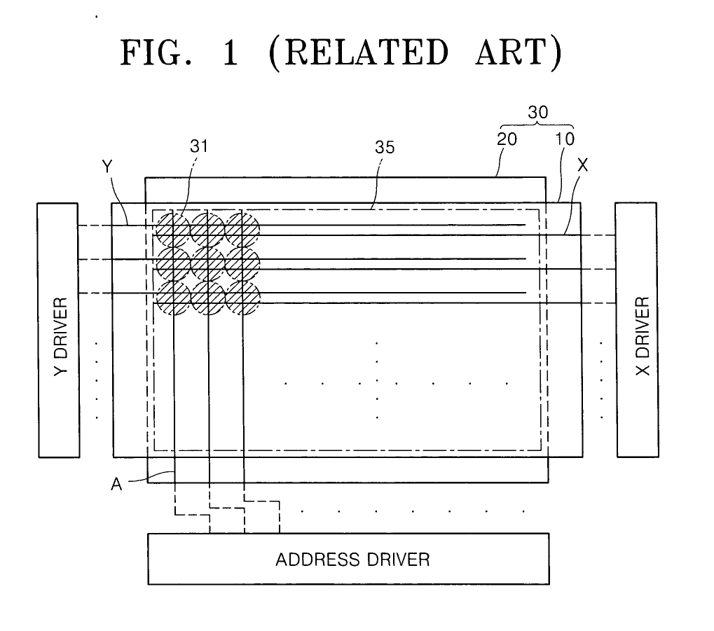

FIG. 2 illustrates a diagram of a plan view of a plasma display module according to a first exemplary embodiment of the present invention;

FIG. 3 illustrates a diagram of a partial, exploded perspective view of the first exemplary plasma display module illustrated in FIG. 2;

FIG. 4 illustrates a diagram of a partial, exploded perspective view of a first exemplary grounding structure that may be employed by the first exemplary plasma display module illustrated in FIG. 3;

FIG. 5 illustrates a diagram of a partial, cross-sectional view taken along the line V-V of the exemplary grounding structure illustrated in FIG. 4, including an enlarged perspective view of an exemplary cable/chassis base arrangement; and

FIG. 6 illustrates a diagram of a partial, exploded perspective view of a second exemplary grounding structure.

### DETAILED DESCRIPTION OF THE INVENTION

Korean Patent Application No. 10-2005-0108298, filed on Nov. 12, 2005, in the Korean Intellectual Property Office, and entitled: “Plasma Display Module,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of regions may be exaggerated for clarity of illustration. It will also be understood that when an element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

Spatially relative terms, such as “beneath,” “below,” “under,” “lower,” “above,” “upper,” “front,” “rear,” and the like, may be used herein for ease of description to describe one element or feature's relationship to another element(s) or feature(s) as illustrated in the accompanying figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation of above and below. The device may be otherwise oriented (rotated 90 degrees or at other orientations), and the spatially relative descriptors used herein interpreted accordingly.

The terminology used herein is for the purpose of describing particular exemplary embodiments only, and is not intended to be limiting of the present invention. As used herein, the singular forms “a,” “an” and “the” are intended to include the plural forms as well, unless the context clearly indicates otherwise.

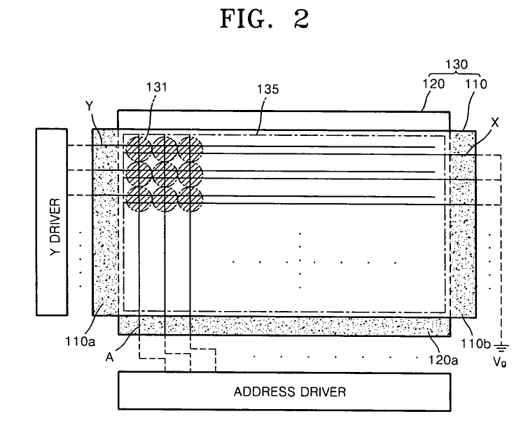

FIG. 2 illustrates a diagram of a plan view of a plasma display module according to an exemplary embodiment of the present invention. Referring to FIG. 2, the plasma display module may include a plasma display panel 130. The plasma display panel 130 may include a first panel 110 and a second panel 120 facing each other. Sustain electrodes X, scan electrodes Y, and address electrodes A may be arranged on the plasma display panel 130. The sustain electrodes X and the scan electrodes Y may extend in parallel to each other. The address electrodes A may extend perpendicular to the sustain electrodes X and the scan electrodes Y. Y and A drivers may be electrically connected to the scan electrodes Y and address electrodes A, respectively. A connection of the sustain electrodes X will be discussed in greater detail below.

A plurality of sub-pixels 131 may be arranged horizontally and vertically in a space 135. The space 135 may be an area where the first panel 110 and the second panel 120 overlap with each other. Each of the sub-pixels 131 may be defined as an area where a sustain electrode X and a scan electrode Y cross an address electrode A.

A pixel may include a plurality of sub-pixels 131. For example, three sub-pixels 131 emitting, for example, different colors, such as red (R), green (G), and blue (B), may constitute a pixel. Although not illustrated in FIG. 2, barrier ribs may be formed between adjacent sub-pixels 131. The barrier ribs may define the sub-pixels 131 as independent discharge spaces.

Terminal areas 110a, 110b, and 120a may be on the outer perimeter of the space 135. For example, the first panel 110 may include the terminal area 110a at its edge. The scan electrodes Y and the Y driver may be electrically coupled to each other on the terminal area 110a. The scan electrodes Y may receive driving signals from the Y driver. The second panel 120 may include the terminal area 120a at its edge. The address electrodes A and the address driver may be electrically coupled to each other on the terminal area 120a. The address electrodes A may receive address signals from the address driver. The first panel 110 may further include the terminal area 110b at its other edge. The sustain electrodes X may be grounded on the terminal area 110b. That is, a ground voltage Vg may be applied to the sustain electrodes X. Thus, an X driver may not be necessary.

By this exemplary arrangement, various discharges may occur. The sustain electrodes X and the scan electrodes Y may form a plurality of sustain electrode X and scan electrode Y pairs. The address electrodes A may generate address discharge in selected sub-pixels 131. Address discharge may occur between, for example, the scan electrodes Y and the address electrodes A. The address discharge may facilitate display discharge between the sustain electrodes X and the scan electrodes Y. An image may be formed by display discharge occurring in each sustain electrode X and scan electrode Y pair.

In a conventional plasma display module, during a sustain period, a voltage pulse may be alternately applied to the sustain electrodes X and the scan electrodes Y. That is, during the sustain period, a sustain discharge voltage and a ground voltage may be alternately applied to each of the sustain electrodes X and the scan electrodes Y. In the present invention, however, during the sustain period, an alternating pulse may be applied to only the scan electrodes Y, and the ground voltage Vg may be applied to the sustain electrodes X.

In the conventional plasma display module, the voltage pulse may include a positive sustain discharge voltage and a ground voltage. The voltage pulse may be applied to the sustain electrodes X and the scan electrodes Y. However, according to the present invention, an alternating pulse may include, for example, a positive sustain discharge voltage and a negative sustain discharge voltage. The alternating pulse may be applied to the scan electrodes Y, and a ground voltage Vg may be applied to the sustain electrodes X. In this way, a sustain discharge voltage having the same voltage difference as that employed in the conventional plasma display module may be applied between the sustain electrodes X and the scan electrodes Y of the plasma display module according to the present invention, while driving only the scan electrodes Y.

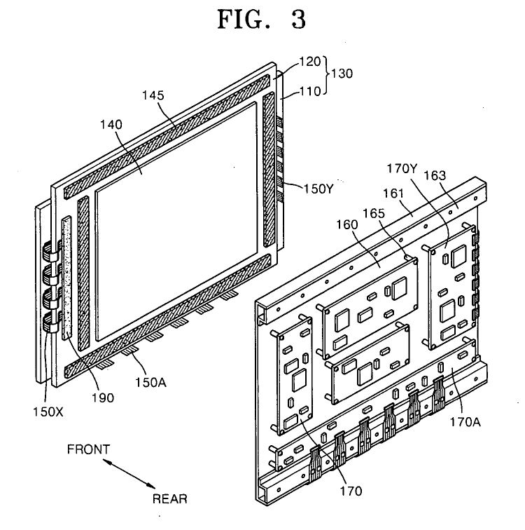

FIG. 3 illustrates a diagram of a partial, exploded perspective view of the plasma display module illustrated in FIG. 2. Referring to FIG. 3, the plasma display module may include the plasma display panel 130. The plasma display panel 130 may include the first panel 110 and the second panel 120. A chassis base 160 may be arranged to a rear of the plasma display panel 130 as a supporting structure for the plasma display panel 130. A heat conduction sheet 140 may be interposed between the plasma display panel 130 and the chassis base 160. The heat conduction sheet 140 may transmit heat generated by the plasma display panel 130 to the chassis base 160. The plasma display panel 130 may be coupled to the chassis base 160 by an adhesive element, such as a dual adhesive tape 145. The dual adhesive tape 145 may be attached along edges of the heat conduction sheet 140.

A plurality of electrodes X, Y, and A may be arranged on the plasma display panel 130. A plurality of driving cables 150X, 150Y, and 150A may extend rearwards from edges of the plasma display panel 130 and transmit signals to the electrodes X, Y, and A. The driving cables 150X may be X driving cables that may transmit a ground voltage to the sustain electrodes X. The driving cables 150Y may be Y driving cables that may be coupled to the scan electrodes Y to transmit a controlled driving signal to the scan electrodes Y. The driving cables 150A may be address driving cables that may be coupled to the address electrodes A to transmit an address signal to the address electrodes A. Each of the driving cables 150X, 150Y, and 150A may include a plurality of conductive patterns. The conductive patterns of the driving cables 150X, 150Y, and 150A may be coupled to the electrodes X, Y, and A. It is to be understood, while FIG. 3 illustrates four ribbon-type driving cables 150X, the number and type of driving cables may be different.

The chassis base 160 may act as a heat conduction plate for the plasma display panel 130. The chassis base 160 may also have a ground connection area. The chassis base 160 may include metal having high heat and high electrical conductivities, such as aluminum (Al). Since the chassis base 160 may support the plasma display panel 130 at its front side and support circuit boards 170 at its rear side, the chassis base 160 may have vertically bent portions 161 along its edges. The vertically bent portions 161 may enhance the support capability of the chassis base 160. In addition, special reinforcing members 163 may be on the rear surface of the chassis base 160.

A plurality of circuit boards 170 for driving the plasma display panel 130 may be arranged on the rear surface of the chassis base 160. In one implementation, the plurality of circuit boards may be coupled to a plurality of coupling bosses 165 formed on the rear surface of the chassis base 160. The plurality of coupling bosses 165 may protrude rearwards by a predetermined length from the rear surface of the chassis base 160.

Some of the circuit boards 170 may be drivers for applying controlled driving signals to the scan electrodes Y and the address electrodes A of the plasma display panel 130. For example, a circuit board 170Y may correspond to the Y driver and may be coupled to the Y driving cables 150Y, as illustrated in FIG. 2. A circuit board 170A may correspond to the address driver and may be coupled to the address driving cables 150A, as illustrated in FIG. 2. In another implementation, the circuit boards 170Y and 170A may be replaced by a single circuit board (not illustrated), and the driving cables 150Y and 150A may be coupled to the single circuit board in a suitable fashion. In another implementation, although not illustrated, the circuit boards 170Y and 170A may be replaced by at least two circuit boards electrically coupled to each other. In addition to the circuit boards 170Y and 170A, the circuit boards 170 may further include a switching mode power supply (SMPS) circuit board, a logic circuit board, etc., that may perform different functions.

The driving cables 150X, however, may not be coupled to any of the circuit boards 170. Rather, the driving cables 150X may instead be grounded to the chassis base 160, as discussed in greater detail below.

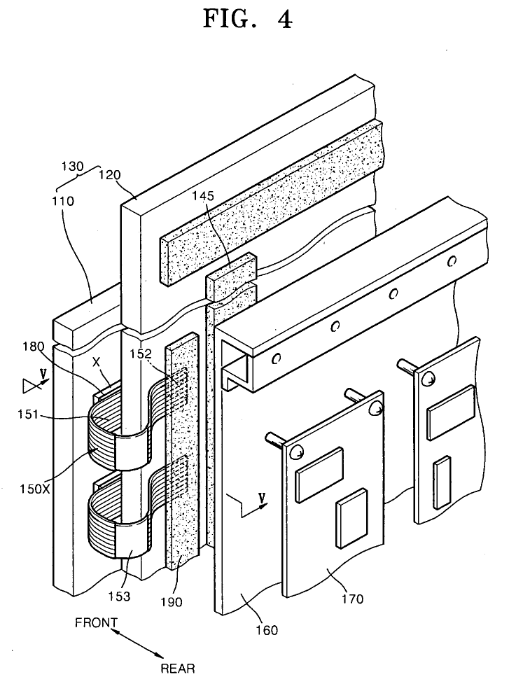

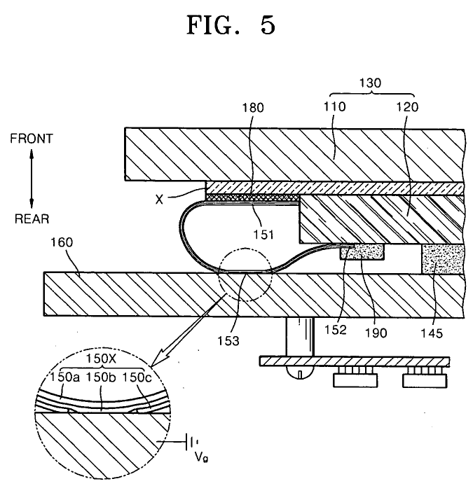

Referring to FIGS. 4 and 5, first ends 151 of the driving cables 150X may be electrically coupled to the sustain electrodes X of the first panel 110. An anisotropic conductive adhesive 180 may be interposed between the sustain electrodes X and the driving cables 150X. The anisotropic conductive adhesive 180 may be a conductive material that applies conductivity only in a direction in which the conductive material is pressed. The first ends 151 of the driving cables 150X may be pressed on the sustain electrodes X with the anisotropic conductive adhesive 180 interposed between them. In this way, the first ends 151 of the driving cables 150X and the sustain electrodes X may be electrically coupled to each other.

The first ends 151 of the driving cables 15OX may extend toward the rear surface of the plasma display panel 130 by forming an arch, such as round curves 153. Second ends 152 of the driving cables 150X may be attached to the rear surface of the plasma display panel 130 with, e.g., an adhesive tape 190. That is, the driving cables 150X may be interposed between the adhesive tape 190 and the plasma display panel 130. The adhesive tape 190 may be tape having a single adhesive side. A double adhesive tape 145 may also be attached to the rear surface of the plasma display panel 130. Once the first and the second ends 151 and 152 of the driving cables 150X are attached on the plasma display panel 130, and the round curves 153 are formed, the chassis base 160 may be coupled to the plasma display panel 130 as illustrated in FIG. 5. The round curves 153 of the driving cables 150X may be pressed to the chassis base 160 and contact the chassis base 160.

Referring to FIG. 5, the driving cable 150X may include a conductive pattern layer 150b and cover films 150a and 150c. The conductive pattern layer 150b may be, for example, a thin layer of copper. The cover films 150a and 150c may be for insulating both sides of the conductive pattern layer 150b. A portion of the cover film 150c may be removed so that the conductive pattern layer 150b is exposed. That is, a portion of the cover film 150c corresponding to the round curve 153 may be removed. The exposed conductive pattern layer 150b may be pressed to contact the chassis base 160. In this way, the driving cable 150X may be directly grounded to the chassis base 160. That is, an area of the round curve 153 of the driving cable 150X may be grounded by the chassis base 160. The chassis base 160 providing a ground voltage Vg.

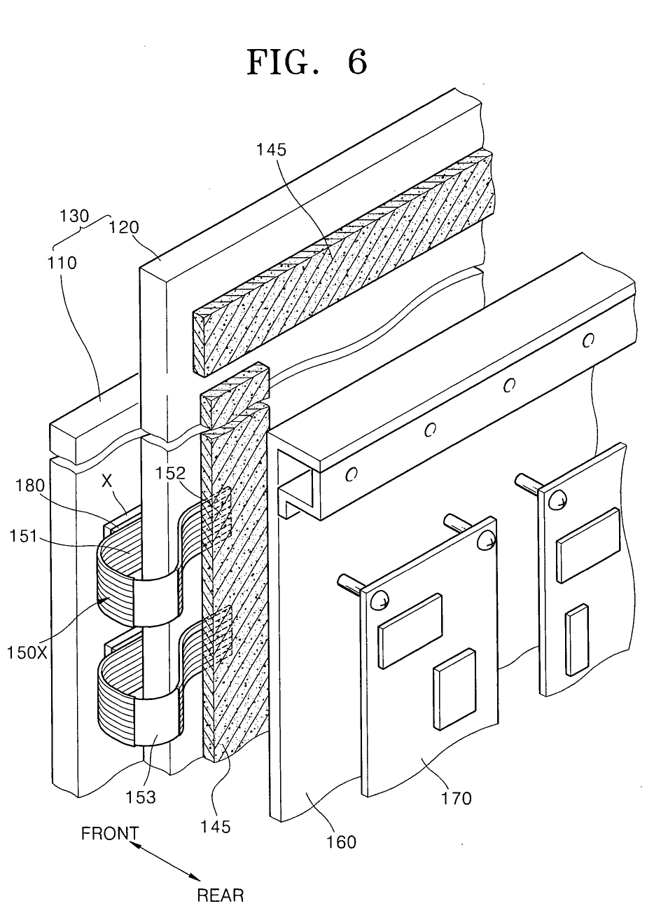

FIG. 6 illustrates a diagram of a partial, exploded perspective view of a second exemplary grounding structure. Like reference numerals are provided to elements that execute the same functions as the elements described above.

Referring to FIG. 6, the plasma display panel 130 may be coupled to the chassis base 160 by the dual adhesive tape 145 interposed between the plasma display panel 130 and the chassis base 160. First ends 151 of driving cables 150X may be electrically coupled to sustain electrodes X of a first panel 110. The first ends 151 of the driving cables 150X may extend toward the rear surface of the plasma display panel 130 by forming round curves 153. Second ends 152 of the driving cables 150X may be attached to the rear surface of the plasma display panel 130. The dual adhesive tape 145 may be interposed between second ends 152 of the driving cables 150X and the chassis base 160. The driving cables 150X that extend from the first ends 151 to the second ends 152 may form the round curves 153. The round curves 153 of the driving cables 150X may include the conductive pattern layer 150b and cover films 150a and 150c. A portion of the cover film 150c may be removed and the exposed conductive pattern layer 150b may contact the chassis base 160 so that the driving cables 150X may be directly grounded to the chassis base 160.

In this second exemplary embodiment, the dual adhesive tape 145 may attach the plasma display panel 130 to the chassis base 160 and attach the driving cables 150X to the plasma display panel 130. Accordingly, in the second exemplary embodiment, special elements, such as separate adhesive tapes for attaching the driving cables 150X to the plasma display panel 130 may not be required. That is, the dual adhesive tape 145 may be attached to the plasma display panel 130 to couple the plasma display panel 130 to the chassis base 160 and also attach the second ends 152 of the driving cable 150X to the plasma display panel 130. Thus, the number of steps required to form the plasma display module may be reduced.

In contrast to conventional plasma display modules, a plasma display module according to the present invention may drive a plasma display panel using a fewer number of circuit boards. That is, a driving circuit board for driving electrodes may be omitted by employing the grounding structure of the present invention. Thus, a plasma display module according to the present invention may be manufactured at a reduced cost. Additionally, design and manufacturing costs associated with controlling heat and vibrations generated by the circuit boards may be reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display module, comprising:
a chassis base having a grounding area;
a plasma display panel attached to the chassis base;
a circuit board configured to supply driving signals to the plasma display panel;
a first driving cable connecting the circuit board to the plasma display panel; and
a second driving cable having a first end connected to the plasma display panel and a second end connected to a rear surface of the plasma display panel, wherein the second driving cable forms a substantially round curve between the first end and the second end, and the substantially round curve contacts and is grounded to the grounding area of the chassis base.

2. The plasma display module as claimed in claim 1, wherein the second driving cable includes:
a conductive pattern layer having a first surface and a second surface; and
a cover film that covers the first surface and a portion of the second surface of the conductive pattern layer, wherein the second surface of the conductive pattern layer is not covered at the substantially round curve so as to electrically contact the grounding area of the chassis base.

3. The plasma display module as claimed in claim 1, wherein the plasma display panel includes an arrangement of electrodes and the first end of the second driving cable connects to an electrode.

4. The plasma display module as claimed in claim 3, wherein the plasma display panel includes a front panel and a rear panel, and the first end of the second driving cable is connected to the electrode at a rear surface of the front panel.

5. The plasma display module as claimed in claim 4, wherein the first end of the second driving cable is connected to the electrode by an anisotropic conductive adhesive.

6. The plasma display module as claimed in claim 3, wherein the arrangement of electrodes includes a scan electrode and a sustain electrode, the first end of the second driving cable connects to the sustain electrode and the first driving cable connects to the scan electrode.

7. The plasma display module as claimed in claim 6, wherein the plasma display module is driven by a repetition of a driving period, and the grounding area of the chassis base provides a ground voltage to the sustain electrode during the driving period.

8. The plasma display module as claimed in claim 1, wherein the plasma display panel includes a front panel and a rear panel, and the second end of the driving cable is attached to a rear surface of the rear panel.

9. The plasma display module as claimed in claim 8, wherein the second end of the second driving cable is attached to a rear surface of the rear panel by an adhesive tape.

10. The plasma display module as claimed in claim 9, wherein the adhesive tape is positioned along a perimeter portion of the rear surface of the rear panel.

11. The plasma display module as claimed in claim 8, wherein the second end of the driving cable is attached to a rear surface of the rear panel by a dual adhesive tape.

12. The plasma display module as claimed in claim 11, wherein the dual adhesive tape is positioned along a perimeter portion of the rear surface of the rear panel.

13. The plasma display module as claimed in claim 12, wherein the dual adhesive tape attaches the plasma display panel to the chassis base.

14. The plasma display module as claimed in claim 1, wherein the grounding area of the chassis base is a front surface of the chassis base.

15. A plasma display module, comprising:
a chassis base having a grounding area;
a plasma display panel attached to the chassis base;
a circuit board configured to supply driving signals to the plasma display panel;
a first driving cable connecting the circuit board to the plasma display panel; and
a second driving cable having a first end and a second end connected to the plasma display panel, wherein a segment of the second driving cable between the first end and the second end contacts and is grounded to the grounding area of the chassis base.

16. The plasma display module as claimed in claim 15, the plasma display panel includes a front panel and a rear panel, wherein the segment of the second driving cable wraps from a rear side of the front panel to a rear side of the rear panel.

17. The plasma display module as claimed in claim 16, the second driving cable includes a conductive layer and cover films covering both sides of the conductive layer, wherein the segment has a portion of the cover film removed so that electrical contact is made between the segment and the grounding area of the chassis base.

18. The plasma display module as claimed in claim 17, wherein the grounding area of the chassis base is a front surface of the chassis base.

19. The plasma display module as claimed in claim 15, wherein the plasma display module includes an arrangement of a scan electrode and a sustain electrode, the first driving cable is connected to a scan electrode, and the first end of the second driving cable is connected to a sustain electrode.

20. The plasma display module as claimed in claim 19, wherein the first end is electrically coupled to the sustain electrode by an anisotropic conductive adhesive.
